(19) United States
(12) Patent Application Publication
(10) Pub. No.: US 2023/0022253 A1
(43) Pub. Date: Jan. 26, 2023

(54) FAST AND ACCURATE PREDICTION METHODS AND SYSTEMS BASED ON ANALYTICAL MODELS

(71) Applicant: AVICENNA.AI, La Ciotat (FR)

(72) Inventor: Christophe AVARE, CEYRESTE (FR)

(73) Assignee: AVICENNA.AI, LA CIOTAT (FR)

(21) Appl. No.: 17/380,238

(22) Filed: Jul. 20, 2021

(51) Int. Cl. G06N 3/04; G06N 3/08

(52) U.S. Cl. CPC G06N 3/0472; G06N 3/08

(57) ABSTRACT

A prediction method to predict a value of a target variable in an input dataset includes analyzing a plurality of instances of the input dataset to predict a plurality of values of the target variable. A supervised machine learning model is trained on the plurality of instances and respective predicted plurality of values, and the trained supervised machine learning model is thereafter used to predict the value of a target variable in the input dataset.

### FIELD OF THE INVENTION

The present invention relates generally to high performance analytical models, and more particularly to computation time versus performance trade-off of such models.

### BACKGROUND OF THE INVENTION

As used herein, the term “analytical model” is meant broadly to include any function, algorithm or logical procedure based on a mathematical or statistical model used to describe the behavior of a phenomenon of interest, either physical, social, financial, biological, chemical or the like. Such analytical models are widely used to predict the value of a target variable in complex phenomena in diverse areas such as meteorology, fluid dynamics, electromagnetism, non-destructive testing, heat diffusion, finance, or medical diagnosis.

One major concern in analytical modeling is to capture and accurately reproduce the behavior of the phenomenon. In this regard, high performance models, for example, arising from very fine discretization, extensive optimization or large-scale parametric models are achieving increasingly satisfactory accuracy. To this end, high resolution and advanced solvers for partial differential equations stiff or non-stiff, nonlinear differential equations, multi objective constrained optimizations, integral equations, nonlinear equations systems, finite element discretizations, statistical distributions, or stochastic equations are usually used.

However, analytical models high accuracy is usually achieved at the expense of increased computational complexity. The higher refinement of analytical models, especially when dealing with low quality information (noise, missing data, low resolution, information distortion, or data acquisition and processing artifacts), requires longer computation time to obtain a reliable prediction. A typical example is stochastic or probabilistic analytical models (such as Markov Chain Monte-Carlo or Bayesian-based approaches) which often outperform other analytical models, but at a higher computational cost.

In other words, highly accurate analytical models may be built for complex systems, as long as there are no constraints on execution time or computation resources. Indeed, various analytical models prove to be highly accurate in many applications, but with a major drawback of long execution time and, consequently, their inappropriateness in real-world applications.

To address this issue, one solution is model reduction by simplifying assumptions about some features of the phenomenon of interest, to alleviate the numerical implementation and required hardware resources and, consequently, reduce the total computational complexity of the model. Nevertheless, this simplification cannot be obtained without compromising and sacrificing the prediction accuracy of the analytical model. Pruning or ignoring some parameters/components of the analytical model adversely affect its performance. Yet another problem may arise with regards to the determination of the appropriate simplification to make with respect to the target application. Thus, a careful and low level optimization demanding specialized skills is required.

Moreover, some simplifications may be insufficient as the quantity of data to process in a given time frame will continue to increase (specially, in the case of dataset provided by very high resolution or multi-spectral sensors, 4K/8K video stream, multi-parametric MRI (Magnetic Resonance Imaging) protocols, or thousands of new texture-based features).

Furthermore, even if a careful optimization is applied to achieve a given balancing between an analytical model's accuracy and computation time, this may be intolerable for some applications, for example in finance or medical diagnosis fields, where both high prediction accuracy and short computation time should be achievable. For instance, in clinical decision making, accuracy and prediction speed are critically important, as incorrect diagnoses or long processing time may have serious consequences. Neither a high-accuracy analytical model with long computing time, nor a simplified analytical model with lower accuracy and computation time is suitable for urgent evaluation requirement where the highest prediction accuracy at lowest cost is required.

### SUMMARY

Various embodiments are directed to addressing the effects of one or more of the problems set forth above. The following presents a simplified summary of embodiments in order to provide a basic understanding of some aspects of the various embodiments. This summary is not an exhaustive overview of these various embodiments. It is not intended to identify key or critical elements or to delineate the scope of these various embodiments. Its sole purpose is to present some concepts in a simplified form as a prelude to the more detailed description that is discussed later.

Some embodiments overcome one or more drawbacks of the prior art by meeting both highest prediction accuracy and lowest computational cost in analytical model-based prediction methods and systems.

Some embodiments enable reproduction of analytical models prediction accuracy in near real-time or real-time applications.

Some embodiments provide accurate and fast prediction methods and systems based on machine learning.

Some embodiments overcome the accuracy vs computation time trade-off of prediction methods and systems based on high-performance analytical models.

Various embodiments relate to a prediction method to predict a value of a target variable in an input dataset, this method including the following steps
using a predefined analytical model on a plurality of instances of the input dataset to predict a plurality of values of the target variable;
training a supervised machine learning model on the plurality of instances and predicted plurality of values;
using the trained supervised machine learning model to predict the value of the target variable in the input dataset.

Various embodiments further relate to a prediction system to predict a value of a target variable in an input dataset, this system including
a predefined analytical model configured to be used on a plurality of instances of the input dataset to predict a plurality of values of the target variable;
a supervised machine learning model configured to be trained on the plurality of instances and predicted plurality of values, trained supervised machine learning model being configured to predict the value of the target variable in the input dataset.

In accordance with a broad aspect, the predefined analytical model has a prediction accuracy above a predefined first threshold.

In accordance with another broad aspect, the predefined analytical model requires, to predict a value of the target variable, a computation time greater than a predefined second threshold.

In accordance with another broad aspect, the supervised machine learning model is a neural network-based model.

In accordance with another broad aspect, an instance of the plurality of instances includes simulated data.

In accordance with another broad aspect, the supervised machine learning model is regularly trained.

In accordance with another broad aspect, the target variable is a categorical variable.

In accordance with another broad aspect, the target variable is a numerical variable.

In accordance with another broad aspect, the predefined analytical model is a stochastic analytical model.

While the various embodiments are susceptible to various modification and alternative forms, specific embodiments thereof have been shown by way of example in the drawings. It should be understood, however, that the description herein of specific embodiments is not intended to limit the various embodiments to the particular forms disclosed.

It may of course be appreciated that in the development of any such actual embodiments, implementation-specific decisions should be made to achieve the developer's specific goal, such as compliance with system-related and business-related constraints. It will be appreciated that such a development effort might be time consuming but may nevertheless be a routine understanding for those or ordinary skill in the art having the benefit of this disclosure.

### DESCRIPTION OF THE DRAWING

The objects, advantages and other features of the present invention will become more apparent from the following disclosure and claims. The following non-restrictive description of preferred embodiments is given for the purpose of exemplification only with reference to the accompanying drawing in which

FIG. 1 schematically illustrates components of a prediction system according to various embodiments;

FIG. 2 schematically illustrates process steps of a prediction method according to various embodiments;

FIG. 3 schematically illustrates elements of a computing device according to various embodiments.

### DETAILED DESCRIPTION OF ILLUSTRATIVE EMBODIMENTS

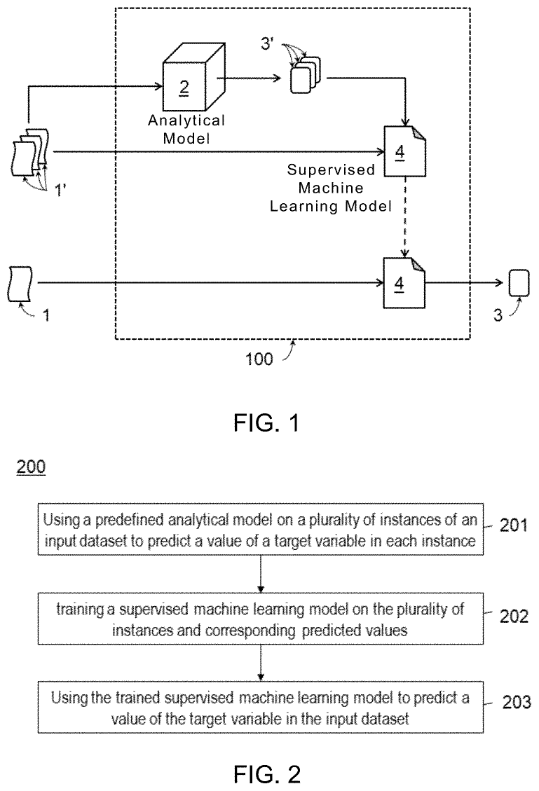

With reference to FIG. 1, there is shown a prediction system 100 configured to predict a value 3 of a target variable in an input dataset 1.

Depending on the intended application of the prediction system 100, the input dataset 1 may be any collection of data of any type and format. For example, the input dataset 1 can be a set of structured data from a database, a text or a multimedia document (images, audio or videos) from information repositories, a web page, or a collection of measurements. The input dataset 1 may include real/simulated data, categorical/numerical data, and/or constant/time-varying data.

For instance, the input dataset 1 includes a medical image provided by a Picture Archiving and Communication Systems (PACS) or, more generally, a set of clinical data provided by a plurality of medical database systems. In other examples, the input dataset 1 may include daily electrical energy consumptions of households, stock prices of a company, measurements of a radio signal, measured meteorological data in a given location, or user behavioral data on an online sales platform.

The input dataset 1 can be of any number of dimensions and comprises at least one (independent or dependent) variable. This variable may be a categorical (qualitative) variable or a numerical variable. A categorical variable may have an inherent order (an ordinal variable) or not (a nominal variable). A numerical variable may be discrete (i.e. having only specific values) or continuous.

In one embodiment, a target variable of interest in the input dataset 1 is a categorical variable so that the prediction system 100 is a classifier (for example, determining whether a medical image is malignant or benign, whether it will rain or not within a given time frame). In this case, the prediction system 100 performs a classification task (binary or multi-class classification) based on the target categorical variable in the input dataset 1. The predicted value 3 of the target variable refers, in this case, to a category.

In another embodiment, the target variable of interest in the input dataset 1 is a numerical variable whose value 3 is to be estimated by the prediction system 100 (for instance, a price, a temperature or a probability of precipitation).

The prediction system 100 comprises an analytical model 2 able to predict a value of the target variable in the input dataset 1 with a prediction accuracy above a predefined threshold (for example, 95%, 98%, 99% or 99,99%). This analytical model 2 is configured to take whatever time is necessary to achieve as high a prediction accuracy as possible.

To achieve a prediction accuracy above the predefined threshold, any relevant feature/parameter of the input dataset 1 is preferably considered by the analytical model 2. These features/parameters may include noise, low resolution, sample size, missing/biased/redundant/inconsistent data, introduced distortion by acquisition and processing means, or feature interdependencies.

More generally, the analytical model 2 is chosen from among models having highest prediction accuracy, regardless of their computational complexity. The computation time of the analytical model 2 may be a few minutes, tens of minutes, a few hours, tens of hours, or more generally, greater than a predefined threshold. Examples of such analytical model 2 are stochastic analytical models such as Markov chain-based analytical models, Bayesian analytical models, or any analytical model based on similar approaches.

In one embodiment, the performance of the analytical model 2 is regularly re-evaluated on a sample set of input dataset 1 so that it can be updated and maintain its prediction accuracy above the predefined threshold.

The analytical model 2 is used on a plurality of instances 1′ of the input dataset 1 to predict a plurality of respective values 3′ of the target variable in each instance 1′ of the input dataset 1.

The prediction system 100 further comprises a supervised machine learning model 4 configured to learn the plurality of instances 1′ of the input dataset 1 and corresponding predicted values 3′ by the analytical model 2. In other words, at least a subset of the plurality of instances 1′ of the input dataset 1 and their corresponding predicted values 3′ are used to train the supervised machine learning model 4 so that it reproduces the behavior of the analytical model 2.

Indeed, the analytical model 2 acts as a reference model for the supervised machine learning model 4. The output of this analytical model 2 is used as the ground truth (or labels) for training the supervised machine learning model 4. Accordingly, the supervised machine learning model 4 is configured to learn (in a supervised setting) the outputs of the reference model without explicitly implementing it. It is the natural comfort zone of machine learning where the behavior of the analytical model 2 may be modeled with high precision by the supervised machine learning model 4.

In one embodiment, a first subset and a second subset of the plurality of instances 1′ of the input dataset 1 and their corresponding predicted values 3′ are, respectively, used to train and test the supervised machine learning model 4. The second subset is different from the first subset.

In various embodiments, a training set of pairs (instance 1′, corresponding predicted value 3′) are used to train the supervised machine learning model 4 as a mapping function from an input dataset 1 to a value 3 of the target variable in the input dataset 1. This mapping function is configured to learn instances 1′ of the input dataset 1 with respect to their values 3′ predicted by the analytical model 2.

In one embodiment, the supervised machine learning model 4 is a convolutional neural network-based model, a recurrent neural network-based model or, more generally, any neural network-based model.

Once trained, the supervised machine learning model 4 is used, at inference time, to predict a value 3 of the target variable in the input dataset 1.

As noted above, and with reference to FIG. 2, the prediction method 200 includes the use (step 201) of the analytical model 2 on the plurality of instances 1′ of the input dataset 1 to predict a plurality of respective values 3′ of the target variable with a prediction accuracy above the predefined threshold. This step 201 aims to form a training set for the supervised machine learning model 4. Thus, during a training step 202, the supervised machine learning model 4 is trained on at least a subset of the plurality of instances 1′ of the input dataset 1 and corresponding predicted values 3′, so as to be able to reproduce the behavior of the analytical model 2. Once trained, it is the supervised machine learning model 4 that is used (step 203) at runtime (inference time) to predict a value 3 of the target variable in any input dataset 1.

Advantageously, the training step 202 allows a complex and long-time first prediction task with trade-off performed by the analytical model to be mapped/transformed to a straightforward and fast (computationally tractable) second prediction task performed by the supervised machine learning model 4, while maintaining substantially the same prediction accuracy (equal or slightly lower). No additional labels other than input/output of the analytical model 2 are required by the supervised machine learning model 4. The creation of labels is automated by the analytical model 2. Accordingly, a massive and long-time computation performed by the analytical model 2 is replaced at runtime (i.e. at inference time) by a short-time massively parallel computation performed by the trained supervised machine learning model 4. Compared to the analytical model 2, the supervised machine learning model 4 is executing the same task while still delivering the same/comparable prediction accuracy in a dramatically lower execution time.

At inference time, only the supervised machine learning model 4 is used to reproduce the results of the analytical model 2, but at lower complexity and shorter computation time. Indeed, when a novel/unseen input dataset 1 is fed to the prediction system 100, the supervised machine learning model 4 predicts almost instantaneously a value 3 of the target variable of interest in this input dataset 1. This allows computation time at inference time to be drastically reduced, because the high computational costs are paid in advance (offline) when using the analytical model 2 to create the training set for the supervised machine learning model 4. The tedious and expensive computational workload of the analytical model 2 may be performed offline. During inference time, the computation time is substantially constant, usually linear with the size of the input dataset 1 and independent from the computational complexity of the analytical model 2.

In one embodiment, only the instances 1′ of the input dataset 1 and the corresponding output values 3′ of the analytical model 2 are known to the supervised machine learning model 4 so that the analytical model 2 may be used in “black-box” mode. Accordingly, the analytical model 2 is, in one embodiment, implemented in a server-side and the supervised machine learning model is, once trained, integrated in client-side. Advantageously, the supervised machine learning model 4 may be integrated in a resource-limited device (such as, a mobile user equipment).

Preferably, the supervised machine learning model 4 is repeatedly trained and validated on recent training and test subsets of a plurality of instances 1′ of the input dataset 1 and corresponding predicted values 3′ by the analytical model 2.

It is to be noted that no assumptions are made on the input dataset 1, only the prediction task (classification, segmentation, regression) and the desired prediction accuracy may be taken into account in the selection of the analytical model 2 and the supervised machine learning model 4. The above-described embodiments can, therefore, be used to model multidimensional (array-like) data mappings, time-based signals, or frequency-domain signals (for example, for signal filtering or spectral analysis).

Advantageously, the above-described embodiments enable definition of the desired prediction accuracy to be reached, regardless of the computation time of the analytical model 2 because this computation time is not experienced by the user. As for the supervised machine learning model 4, and unlike the analytical model 2 which is heavily constrained by the information quality in the instances 1′ of the input dataset 1, it only needs to be consistent with the prediction task (classification, segmentation, regression). Consequently, a large choice of models from various supervised machine learning techniques is readily available.

In one embodiment, at least one instance 1′ of the input dataset 1 includes simulated data. For example, many algebraic or stochastic generative processes can be learned and made robust with simulated noise addition or other suitable simulation data augmentation techniques.

In an illustrative embodiment, an application of the prediction method 200 and system 100 is a fast and high accuracy clinical data diagnosis task. This task comprises a myocardial multi-class segmentation. The input dataset 1 is a modified look locker inversion recovery (MOLLI) signal (inversion pulses with multiple images) and the target variable is the myocardial T1 relaxation time. The analytical model 2 is an analytical Cardiac Magnetic Resonance (CMR) model configured to predict a value of the myocardial T1 relaxation time (or mapping the MOLLI signal to a myocardial T1 value) of the myocardium to identify infracted myocardial regions. This analytical model 2 uses a Markov chain Monte Carlo (MCMC) approach with Bayesian prior estimates to achieve a very high accuracy. This analytical model 2 needs, before hardware optimization, around 15 minutes per slab/slice which leads to 1.5 hours for each pre- or post-injection acquisition for the 6-7 slices of this protocol.

To make this analytical model 2 compatible with clinical practice, a supervised machine learning model 4 (a neural network-based model) is configured to learn the output of the analytical CMR model 2. In fact, once a plurality of myocardial T1 values have been calculated, the resulting dataset is used, with corresponding MOLLI signals, as a training set for the supervised machine learning model 4. For instance, this supervised machine learning model 4 may be trained on approximately 20 k samples in less than 10 minutes (the model having 2500 parameters). At inference time, the prediction of myocardial T1 values by the supervised machine learning model 4 is almost instantaneous with accurate non-biased myocardial T1 estimates suitable for clinical diagnoses.

In another embodiment, the analytical model 2 is a sophisticated weather or climate model running on high performance clusters. This analytical climate model 2 may be of a single large analytical model or a stack of specialized sub-models (for instance, specialized sub-models to some modeling scale or set of conditions such as in space (location, like sea, mountain, or sport area), time (prediction horizon like daily, weekly) or both like storm path). Analytical climate model 2 is usually defined through multiple differential equations requiring the finest computing grids to predict climate features such as precipitation, air temperature, humidity, wind force and direction, or sunlight duration. These predicted variables are by nature smooth, continuous and the analytical climate model 2 is entirely defined by the initial conditions. This analytical climate model 2 can be abstracted away by a supervised machine learning model 4 based on a large training data set including historical input and output data of this analytical climate model 2. The advantage of such approach is that, once correctly trained, the supervised machine learning model 4 can be run very quickly and more often on the existing infrastructure, thus providing at the same time more accurate and frequent data, compensating for the cumulative inaccuracies experienced in existing approaches when the prediction horizon is extended.

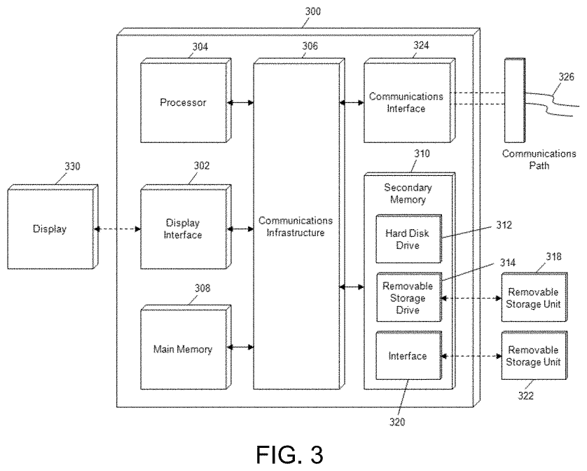

FIG. 3 illustrates a computer system 300 in which embodiments of the present disclosure, or portions thereof, may be implemented as computer-readable code. For example, one or more (e.g., each) of the analytical model 2, the supervised machine learning model 4, and other device described herein may be implemented in the computer system 300 using hardware, software, firmware, non-transitory computer readable media having instructions stored thereon, or a combination thereof and may be implemented in one or more computer systems or other processing systems. Hardware, software, or any combination thereof may embody modules and components used to implement the method of FIG. 2.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above-described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 318, a removable storage unit 322, and a hard disk installed in hard disk drive 312.

Various embodiments of the present disclosure are described in terms of this example computer system 300. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multiprocessor machines. In addition, in some embodiments the order of operations may be rearranged without departing from the spirit of the disclosed subject matter.

Processor device 304 may be a special purpose or a general purpose processor device specifically configured to perform the functions discussed herein. The processor device 304 may be connected to a communications infrastructure 306, such as a bus, message queue, network, multi-core message-passing scheme, etc. The network may be any network suitable for performing the functions as disclosed herein and may include a local area network (LAN), a wide area network (WAN), a wireless network (e.g., Wi-Fi), a mobile communication network, a satellite network, the Internet, fiber optic, coaxial cable, infrared, radio frequency (RF), or any combination thereof. Other suitable network types and configurations will be apparent to persons having skill in the relevant art. The computer system 300 may also include a main memory 308 (e.g., random access memory, read-only memory, etc.), and may also include a secondary memory 310. The secondary memory 310 may include the hard disk drive 312 and a removable storage drive 314, such as a floppy disk drive, a magnetic tape drive, an optical disk drive, a flash memory, etc.

The removable storage drive 314 may read from and/or write to the removable storage unit 318 in a well-known manner. The removable storage unit 318 may include a removable storage media that may be read by and written to by the removable storage drive 314. For example, if the removable storage drive 314 is a floppy disk drive or universal serial bus port, the removable storage unit 318 may be a floppy disk or portable flash drive, respectively. In one embodiment, the removable storage unit 318 may be non-transitory computer readable recording media.

In some embodiments, the secondary memory 310 may include alternative means for allowing computer programs or other instructions to be loaded into the computer system 300, for example, the removable storage unit 322 and an interface 320. Examples of such means may include a program cartridge and cartridge interface (e.g., as found in video game systems), a removable memory chip (e.g., EEPROM, PROM, etc.) and associated socket, and other removable storage units 322 and interfaces 320 as will be apparent to persons having skill in the relevant art.

Data stored in the computer system 300 (e.g., in the main memory 408 and/or the secondary memory 310) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 300 may also include a communications interface 324. The communications interface 324 may be configured to allow software and data to be transferred between the computer system 300 and external devices. Exemplary communications interfaces 324 may include a modem, a network interface (e.g., an Ethernet card), a communications port, a PCMCIA slot and card, etc. Software and data transferred via the communications interface 324 may be in the form of signals, which may be electronic, electromagnetic, optical, or other signals as will be apparent to persons having skill in the relevant art. The signals may travel via a communications path 326, which may be configured to carry the signals and may be implemented using wire, cable, fiber optics, a phone line, a cellular phone link, a radio frequency link, etc.

The computer system 300 may further include a display interface 402. The display interface 302 may be configured to allow data to be transferred between the computer system 300 and external display 330. Exemplary display interfaces 302 may include high-definition multimedia interface (HDMI), digital visual interface (DVI), video graphics array (VGA), etc. The display 330 may be any suitable type of display for displaying data transmitted via the display interface 302 of the computer system 300, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 308 and secondary memory 310, which may be memory semiconductors (e.g., DRAMs, etc.). These computer program products may be means for providing software to the computer system 300. Computer programs (e.g., computer control logic) may be stored in the main memory 308 and/or the secondary memory 310. Computer programs may also be received via the communications interface 324. Such computer programs, when executed, may enable computer system 300 to implement the present methods as discussed herein. In particular, the computer programs, when executed, may enable processor device 304 to implement the methods illustrated by FIG. 2, as discussed herein. Accordingly, such computer programs may represent controllers of the computer system 300. Where the present disclosure is implemented using software, the software may be stored in a computer program product and loaded into the computer system 300 using the removable storage drive 314, interface 320, and hard disk drive 312, or communications interface 324.

The processor device 304 may comprise one or more modules or engines configured to perform the functions of the computer system 300. Each of the modules or engines may be implemented using hardware and, in some instances, may also utilize software, such as corresponding to program code and/or programs stored in the main memory 308 or secondary memory 310. In such instances, program code may be compiled by the processor device 304 (e.g., by a compiling module or engine) prior to execution by the hardware of the computer system 300. For example, the program code may be source code written in a programming language that is translated into a lower level language, such as assembly language or machine code, for execution by the processor device 304 and/or any additional hardware components of the computer system 300. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 300 to perform the functions disclosed herein. It will be apparent to persons having skill in the relevant art that such processes result in the computer system 300 being a specially configured computer system 300 uniquely programmed to perform the functions discussed above.

Advantageously, the above-described embodiments
allow computation/processing time (i.e. the time required to compute a prediction) to be drastically reduced without sacrificing accuracy and generalization performances. This is particularly aligned with situations requiring urgent evaluation (such as clinical presentations) that should not be provided at the cost of lower accuracy;
allow the trade-off between the accuracy and computation time of analytical models to be coped with;
enable near real-time and real-time prediction applications where both high accuracy and low computational cost are achieved together;
provide much faster surrogate models than analytical models, while achieving substantially the same prediction accuracy; and
allow a serial computing procedure to be transformed into massively parallel one.

1. A prediction method to predict a value of a target variable in an input dataset, comprising the following steps:
analyzing a plurality of instances of the input dataset, using a predefined analytical model, to predict a plurality of respective values of target variables;
training a supervised machine learning model on said plurality of instances and respective predicted plurality of values; and
using the trained supervised machine learning model to predict the value of a target variable in said input dataset.

2. The prediction method of claim 1, wherein the predefined analytical model has a prediction accuracy above a predefined first threshold.

3. The prediction method of claim 1, wherein the predefined analytical model requires, to predict a value of the target variable, a computation time greater than a predefined second threshold.

4. The prediction method of claim 1, wherein the supervised machine learning model is a neural network-based model.

5. The prediction method of claim 1, wherein an instance of said plurality of instances includes simulated data.

6. The prediction method of claim 1, wherein the supervised machine learning model is repeatedly trained.

7. The prediction method of claim 1, wherein the target variable is a categorical variable.

8. The prediction method of claim 1, wherein the target variable is a numerical variable.

9. The prediction method of claim 1, wherein the predefined analytical model is a stochastic analytical model.

10. A prediction system to predict a value of a target variable in an input dataset, comprising:
a predefined analytical model configured to analyze a plurality of instances of the input dataset to predict a plurality of respective values of the target variable; and
a supervised machine learning model that is trained on said plurality of instances and respective predicted plurality of values, to thereby configure the trained supervised machine learning model to predict said value of a target variable in said input dataset.

11. The prediction system of claim 10, wherein the predefined analytical model is able to predict a value of the target variable with a prediction accuracy above a predefined first threshold.

12. The prediction system of claim 10, wherein the predefined analytical model requires, to predict a value of the target variable, a computation time greater than a predefined second threshold.

13. The prediction system of claim 10, wherein the supervised machine learning model is a neural network-based model.

14. The prediction system of claim 10, wherein an instance of said plurality of instances includes simulated data.

15. The prediction system of claim 10, wherein the supervised machine learning model is repeatedly trained.

16. The prediction system of claim 10, wherein the target variable is a categorical variable.

17. The prediction system of claim 10, wherein the target variable is a numerical variable.

18. The prediction system of claim 10, wherein the predefined analytical model is a stochastic analytical model.
